(19) United States
(12) Patent Application Publication
(10) Pub. No.: US 2007/0059471 A1
(43) Pub. Date: Mar. 15, 2007

(54) Trash bag separator

(76) Inventor: Charles Michael Sanford, Alexandria, VA (US)

Correspondence Address: CHARLES M. SANFORD, 510A EAST HOWELL AVE, ALEXANDRIA, VA, 22301, US

(21) Appl. No.: 11/165,499

(22) Filed: Sep. 12, 2005

(51) Int. Cl. B32B 33/00

(52) U.S. Cl. 428/40.1

(57) ABSTRACT

The Trash Bag Separator, as the name implies is an apparatus to aid in the initial opening of plastic bags such as grocery bags and trash bags. The Trash Bag Separator resembles a plastic credit card folded in half, with adhesive edge paper on each of the inner sides, with the sticky strip on the outer edge. To use the invention, the user places the “book” over the open end of the bag and closes it. The spring nature of the binding causes the “book” to open when released. The sticky paper then separates the two halves of the bag allowing it to be open with ease. The bag can then be removed from the Trash Bag Separator, and the invention is ready to reuse on the next bag.

### BACKGROUND OF INVENTION

The use of plastic bags to carry groceries and other purchased items has almost completely replaced paper bags. Their increased strength, reduced tendency to tear, resistance to rain and water, small storage space, and reduced environmental impact makes them popular with just about all. However, one disadvantage all types of plastic bags posses is that they are very difficult to open. Their thin nature coupled with their manufacturing and cutting methods, make separating the opening during initial use makes for one of the most aggravating and frustrating task imaginable. While opening a plastic bag is a difficult task for a young, energetic and fit person, it is almost an impossibility for the elderly, those with diminished eyesight, or those with reduced physical dexterity. Accordingly, there exists a need for a means by which plastic bags can be initially opened in a quick and easy manner. The development of the Trash Bag Separator fulfills this need.

### BRIEF SUMMARY OF THE INVENTION

The invention resembles a small book, which when opened, has the overall dimensions of a credit card. Each half of the book has separate pages comprised of sticky note pads similar in nature to Post-it7 pads. The pads are position such that when closed, the sticky faces are facing one another. To avoid this, a cellophane separator is positioned in the middle to keep the pages from sticking to themselves.

To use the invention, the user places the “book” over the open end of the bag and closes it. The spring nature of the binding causes the “book” to open when released. The sticky paper then separates the two halves of the bag allowing it to be open with ease. The paper pages can then be removed from the bag, and the invention is ready to reuse on the next bag. The use of the Trash Bag Separator allows one to open plastic bags with relative ease, thus saving time and aggravation in a manner, which is quick, easy and effective.

### BRIEF DESCRIPTION OF THE SEVERAL VIEWS OF THE DRAWING

FIG. 1 The plastic outer shell of the Trash Bag Separator, which is the approximant size of a credit card.

FIG. 2 The plastic center piece, fastens the adhesive paper to the shell, and help create a natural spring when folded in half.

FIG. 3 The left side of the adhesive paper (5 sheets), similar to a post-it7 pad, sticky surface 1.

FIG. 4 The right side of the adhesive paper (5 sheets), similar to a post-it7 pad, sticky surface 2.

FIG. 5 This drawing represents the shell 4 with the first sheets of adhesive paper 5,and 6 on both sides, and the center piece 3.

FIG. 6 The cellophane sheet that protects the sticky surface of the adhesive paper.

FIG. 7 This drawing represents the front view of the Trash Bag Separator assembled. 7 is FIG. 2, 8 is hole for hanging, 9 is FIG. 1, 10 is FIG. 3, 11 is FIG. 4.

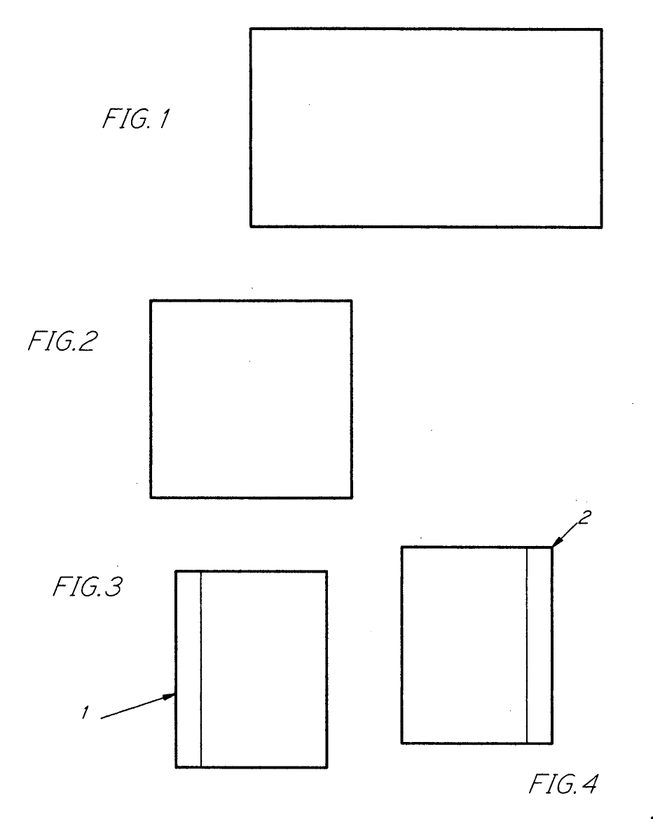

### DETAILED DESCRIPTION OF THE INVENTION

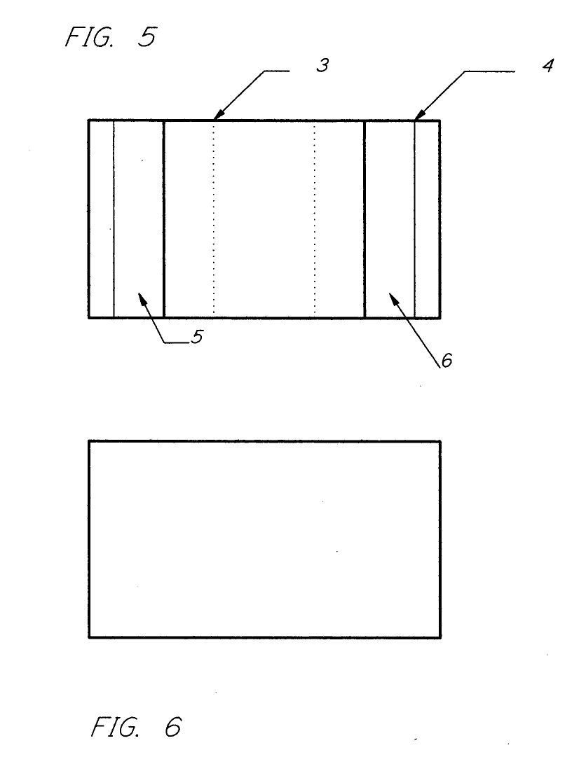

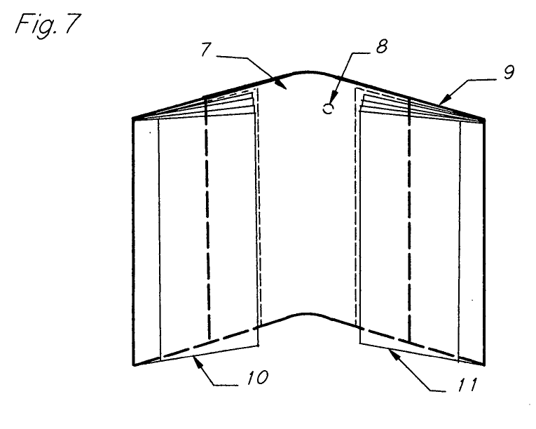

As designed, Trash Bag Separator has many features that make it beneficial to both consumers and potential manufactures. The invention's features and the benefits they provide are highlighted as follows:

| Features | Benefit |
|---|---|
| Plastic Bag Separator | Used with plastic garbage bags, grocery bags |
| FIG. 7, front | and the like. |
| | Helps to separate bag halves and make opening |
| | easier. |
| | Provided with (.25″ dia.) hole for hanging. |
| | Reduces aggravation. |
| | Saves time. |
| Outer Shell, FIG. 1 | Made of plastic |
| | Approx. size of credit card when opened |
| | (2.25″ × 3.37″ × .0312″), size may vary. |
| | Spring nature of binding allows it to automati- |
| | cally open when released. |
| | Paper pages, FIG. 3 and FIG. 4, similar to small |
| | Post-it7 Pads, Size (2.25″ × 1.25″), size |
| | may vary. |
| | Grabs the two halves of the bag. |
| | Multiple Pages, (5 sheets on each side). |
| | Can be peeled off to expose new pages as |
| | needed. |
| Plastic Center Piece, | Made of plastic. |
| | Fastens the paper pages to Outer Shell with |
| | glue, as shown in FIG. 5 (5 and.6). |
| | Fasten with glue, in middle of shell, FIG. 1 |
| | Help spring nature of binding. |
| | Size (2.25″ × 1.5″ × .0312″), size may vary. |
| Cellophane Separator, | Used as separator. |
| | Size (2.25″ × 3.37″), size may vary. |
| | Keeps Pages from sticking to one another |
| | when closed. |
| Marketing aid | Can be imprinted with company name, logo, |
| | etc, on cover. |
| | Can be given away free as a marketing gimmick. |
| | Provide free advertising since consumer will |
| | use again and again. |
| Material Construction | Readily available materials. |
| | Easy to manufacture. |
| | Known technology. |
| | Cost-effective design. |

The material required to produce the Trash Bag Separator are already available and well known to manufacturers of goods of this type. The shell or outer covering of the invention would be made in an injection molding process. Such a process would require the design and use of custom molds. The remaining components of the invention, such as the sticky paper pads and the cellophane separator would best be obtained from wholesalers and manufactures that deal in goods of that nature and assembled at a final location. The relatively simple design of the invention and the material of construction make the Trash Bag Separator a cost-effective design due to the relatively low material and labor cost involved. Final production of the Trash Bag separator will be performed by manufacturing workers of average skill.

I claim:

1. By placing the top of a plastic bag between the two adhesive sides of the Trash Bag Separator. Closing the Trash Bag Separator will cause the adhesive to stick to the outer edge of the plastic bag. When the pressure is released the bag will open from the spring like action of the plastic binder.

2. The Trash Bag Separator can be used several times to open plastic bags by replacing the cellophane separator.

3. The Trash Bag Separator will have five layers of adhesive sheets that can be removed when the top layer is no longer useable.
